(19) United States
(12) Patent Application Publication
(10) Pub. No.: US 2006/0195886 A1
(43) Pub. Date: Aug. 31, 2006

(54) Content identification for broadcast media

(75) Inventor: Alexis S.R. Ashley, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Groenewoudseweg 1 (NL)

(21) Appl. No.: 10/565,667

(22) PCT Filed: Jul. 22, 2004
(86) PCT No.: PCT/IB04/02383

§ 371 Date: Jan. 23, 2006

(30) Foreign Application Priority Data
Jul. 26, 2003 (GB) 0317571.8

(51) Int. Cl. H04N 7/167; H04N 11/00; H04N 7/00; H04N 7/16

(52) U.S. Cl. 725/138; 348/468; 348/461; 725/31

(57) ABSTRACT

A method and apparatus for repeatedly embedding content identification information (identifiers) into a media data stream, such as an MPEG video data stream. The identifiers are embedded into the data stream using a hash function that binds an identifier with a rapidly varying property of the data stream so that it is difficult for an unauthorised device to insert false identifier information or to edit the identifier information. The identifier may be secured also with a digital signature. The method and apparatus also provides for transcoding of the data stream and re-calculation of the embedded identifier, by an authorised device, where the rapidly varying property of the data stream may be altered by the transcoding operation.

### TECHNICAL FIELD OF THE INVENTION

The present invention relates to methods and apparatus for embedding content identification information into a media stream such as a video data stream.

### BACKGROUND ART

When media content, such as pictures, audio files, video files and the like, are distributed across a network, eg. a peer-to-peer network, it is difficult for the end user to be sure that the media content is what it purports to be. Problems can arise in a number of circumstances.

For example, an ID3 tag placed in an MP3 file labels the content of the file, eg. with the track title. However, this tag is only placed in the file once. If the recording that generated the file was stopped prior to the completion of the source file, then the tag is eliminated, and the file content becomes unknown.

In another example, the media content may have been deliberately labelled to pretend to be something that it is not, or to attribute the media content to a false source of origin. Some peer-to-peer technologies attempt to overcome this problem by using a hashing function on data derived from the media content to form a ‘watermark’ that cannot easily be tampered with by the end user.

There are a number of existing systems proposed for inserting ‘watermark’ information into video data streams for the purposes of authentication. An example is described in US 2002/0178368, which utilises a two-stage system to generate a robust watermark component and a fragile watermark component. The fragile component is designed so that the watermark is easily damaged or destroyed when under attack so that a hacker cannot use it. However, the robust component is designed so that it does not lose its integrity when normal media stream delivery operations are performed on it. For example, normal transcoding operations to reduce bit rate when the data stream is to be transferred over a low bandwidth channel will leave the robust watermark component intact.

In the system of US 2002/178368, extracted feature data MF and MR are derived from block level data of an MPEG I-frame and these data are fed into a hashing algorithm, and the output is subjected to private/public key encryption and the resulting watermark information is embedded into the video stream at two different levels to provide the fragile component and the robust component which respectively enable detection of tampering at the block level and the group level.

A problem with the use of hash functions is that they will only produce the same data output if the two media data streams are bit-for-bit identical. If two different devices record the same broadcast content (eg. from a digital satellite), they will not be bit-for-bit identical. This will be due not least because of different times at which the respective recordings stopped and started, and also because of any transmission drop outs that occurred during reception of the broadcast.

### OBJECT OF INVENTION

It is an object of the present invention to provide a secure method of providing content identification and/or authentication on media data streams that may not be bit-for-bit identical.

It is a further object of the invention to provide a method of providing content identification and/or authentication on media data streams that may not be co-extensive in length such that a content tag may be missing.

It is a further object of the invention to provide a method for reliably enabling comparison of two differing media data streams to establish whether they relate to the same media content.

### SUMMARY OF INVENTION

According to one aspect, the present invention provides a method for providing content identification within a media data stream comprising the steps of:

receiving a data stream of media content;

inserting content identification data at regular intervals within the media data stream.

According to another aspect, the present invention provides a method for providing tamper resistant content identification within a media data stream, comprising the steps of:

receiving a data stream of media content;

extracting data relating to a predetermined property of the media data stream;

combining the extracted data with content identification data;

forming a hash code from the combined data;

applying a digital signature to the hash code; and

inserting the hash code and digital signature as secured content identification data into the data stream.

According to another aspect, the present invention provides a method of transcoding a media data stream comprising the steps of:

receiving a data stream of media content including embedded, secured content identification data, in which the secured content identification data incorporates data relating to a predetermined property of the media data stream;

transcoding the media content of the data stream into a new format;

extracting data relating to a predetermined property of the media data stream in its new format;

extracting content identification data from the secured content identification data;

combining the extracted data with the extracted content identification data;

applying a digital signature to the combined data; and

inserting the combined data and digital signature as re-secured content identification data into the data stream.

According to another aspect, the present invention provides a method of verifying the integrity of secured content identification data embedded in a media data stream, comprising the steps of:

receiving a data stream of media content including embedded, secured content identification data, in which the secured content identification data incorporates data relating to a predetermined property of the media data stream;

extracting first data relating to a predetermined property of the media data stream;

extracting content identification data from the secured content identification data;

extracting second data relating to the predetermined property from the secured content identification data;

comparing the first data and the second data to verify the authenticity of the extracted content identification data.

According to another aspect, the present invention provides an apparatus for providing content identification within a media data stream comprising:

means for receiving a data stream of media content; and

means for inserting content identification data at regular intervals within the media data stream.

According to another aspect, the present invention provides an apparatus for transcoding a media data stream, comprising:

means for receiving a data stream of media content including embedded, secured content identification data, in which the secured content identification data incorporates data relating to a predetermined property of the media data stream;

a transcoder module for transcoding the media content of the data stream into a new format;

a data extraction module for extracting data relating to a predetermined property of the media data stream in its new format and for extracting content identification data from the secured content identification data;

means for combining the extracted data with the extracted content identification data;

an encryption module for applying a digital signature to the combined data; and

a data merge module for inserting the combined data and digital signature as re-secured content identification data into the data stream.

According to another aspect, the present invention provides an apparatus for verifying the integrity of secured content identification data embedded in a media data stream, comprising:

means for receiving a data stream of media content including embedded, secured content identification data, in which the secured content identification data incorporates data relating to a predetermined property of the media data stream;

a data extraction module for extracting first data relating to a predetermined property of the media data stream;

a decryption module for extracting content identification data from the secured content identification data; and for extracting second data relating to the predetermined property from the secured content identification data; and

a compare module for comparing the first data and the second data to verify the authenticity of the extracted content identification data.

### BRIEF DESCRIPTION OF THE DRAWINGS

Embodiments of the present invention will now be described by way of example and with reference to the accompanying drawings in which:

FIG. 1 shows a schematic block diagram of an apparatus for inserting content identification information into a media data stream;

FIG. 2 shows a schematic block diagram of a transcoder device for transcoding the media stream output of the device of FIG. 1, while maintaining the integrity of embedded content identification information;

FIG. 3 is a flowchart illustrating the steps of inserting content identification information into a media data stream;

FIG. 4 is a schematic block diagram of a receiving device for extracting and verifying content identification information embedded in a data stream; and

FIG. 5 is a flowchart illustrating the steps of extracting and verifying content identification information embedded in a data stream.

### SPECIFIC DESCRIPTION OF THE EMBODIMENTS

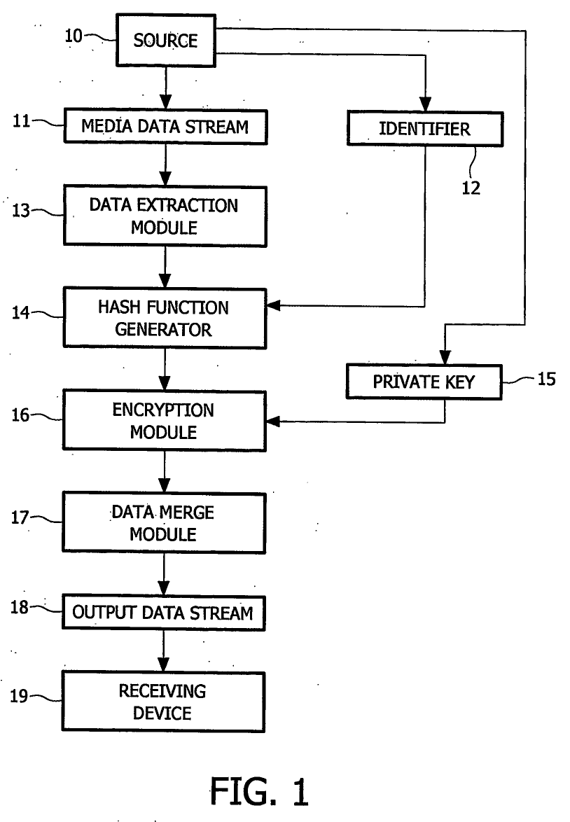

With reference to FIG. 1, a programme of media content is provided for broadcast, transmission or other form of distribution, by a media content data source 10, as a media data stream 11. The source 10 also provides an identifier 12, to be repeatedly embedded into the media data stream 11.

The identifier 12 may be any item of identification data originated by the media content provider 10, for example indicating some nature of the media content. This ‘content identification data’ may include the identity of the content provider, the name or title of the media (eg. film name or song title), and/or information relating to its subject matter (eg. whether the media content is a pay-per-view movie or a free-to-view advert). The identifier 12 is to be embedded into the media data stream at frequent intervals, preferably regular or periodic intervals, for example within each frame of data to be transmitted to a third party device 19.

In a first aspect, the repeated inclusion of the content identification data, eg. into every frame of a movie, provides a first level of security making it difficult for an unauthorised third party to tamper with the identifier, in that it must be edited for each and every occurrence. In addition, if a recording of the movie is terminated early, or not started at the beginning, it will still be possible to ascertain the identity of the media stream since the identifier is repeated at frequent intervals.

Therefore, in principle, this identifier 12 could be used by any receiving devices to verify that two copies of the media data stream 11 are in fact the same. However, on its own, the identifier 12 is not ideal because it is still relatively easy for a fraudulent third party to insert the same identifier into any content they choose, simply by copying the identifier. In practice, the identifier 12 should preferably be protected in such a manner that it cannot easily be inserted into a media data stream 11 and such that any identifier can be verified as authentic, eg. belonging to a particular broadcast source. The verifiability of authenticity of the identifier enables a receiving device to decide whether the source of the transmitted media data stream is a trustworthy source.

The first step to providing tamper resistance of the identifier is to use some rapidly changing property of the media data stream that is difficult to alter. For example, in an MPEG2 video data stream, the rapidly changing property may comprise one or more of: a PID (the transport stream identifier); one or more PCR clock signals in the stream; a continuity count that increments for each data packet; a frame size; and a hashcode for a selected frame.

The frame size property may be the size in bytes of a compressed frame of video or audio or still picture. The frame hashcode may be the result of passing the compressed bytes of the video, audio or still picture through a selected hashing function. The PID may be any stream identifier for an interleaved or multiplexed set of separate data streams.

Preferably, the rapidly changing property of the data stream 11 is one which changes with each video data frame. More preferably, the rapidly changing property is a combination of the frame size and the frame hash. The rapidly changing property is used to generate or extract data that can be combined with the identifier to make it difficult to copy and insert identifiers.

Data relating to the rapidly changing property is extracted by suitable data extraction module 13 and combined with the identifier 12 at a hash function generator 14 to form a hash code output. Any appropriate mathematical combination of the extracted data and the content identification data may be used to generate the combined data, eg. hash code.

The hash code output of the hash function generator 14 is provided to an encryption module 16 together with the private key 15 of the source 10. The encryption module 16 digitally signs the hash code such that its authenticity can be verified by a third party having access to the corresponding public key of the source 10.

The digitally signed hash code output of the encryption module 16 (ie. the ‘secured’ content identification data) is then inserted into the data stream by a data merge module 17 to form output data stream 18. In preferred arrangements, the digitally signed hash code (secured content identification data) is inserted periodically and in conjunction with the data frame or block to which it relates, ie. by reference to the rapidly varying property from which the property data was extracted.

The output data stream 18 is passed to a receiving device 19 using any appropriate data transmission medium. This could be over a conventional wireless or wired transmission network in real time continuous transmission or packetised. Alternatively, the output data stream could be provided to the receiving device 19 by way of a suitable physical data carrier such as a disk, tape, random access memory or the like.

The stream property selected by data extraction module 13 for combination with the identifier 12 is preferably chosen to make it difficult to insert the identifier into an incorrect piece of content. For example, it would be almost impossible to engineer a video stream in such a manner that the frame size and hash codes of every I frame matched that of the inserted identifier.

The hashing function applied to the identifier 12 and the extracted stream property data make it very difficult to alter either the property or the identity because the hash would no longer be correct. The identifier 12 is used by a receiving device 19 to determine the true content and/or origin of the data as provided by the data source 10. The digital signature applied by encryption module 16 makes it impossible to alter the identifier without detection, because decryption using the public key of the source 10 would no longer provide an output that matched the identity of the source 10.

The various elements of the media data stream generator of FIG. 1 (eg. data extraction module 13, hash function generator 14, encryption module 16 and data merge module 17) may be implemented as hardware or software modules within a media data stream generator device. The embedding of the identifier into the media data stream may be carried out in real time during creation of the data stream or after creation / copying of the media data stream. Where the selected stream property includes a hash of frame data, the hash function generator 24 may also compute the frame hash prior to carrying out the hash combination with the identifier 22.

The particular frame data stream property used may be chosen to be one that will survive any authorised data processing of the data stream, eg. re-multiplexing.

One method of compromising the security of a digitally signed identifier is to provide a receiver device 19 with a false public key. In this way, the identifier 12 can be corrupted or altered by a fraudulent party, and a false public key distributed so that the receiver device cannot detect the lack of a genuine signature on the data. In this way, the fraudulent party can falsely sign media content such that any receiving device using the false public key will obtain a matching signature.

The conventional way to provide security against such fraudulent activity is to use public key certificates. A certificate contains the public key of the data source 10 and the identity and digital signature of a trusted third party. If the third party is trusted, then the certificate can be assumed to contain the true public key of the source 10. There is usually provided a tree of certificates eventually ending up at one of a few root certificate authorities that are well known as trusted third parties.

The certification tree can be used in the tamper resistant content identifier system described above to detect who created the identifier 12. The signature embedded in the broadcast media data stream 18 received by the receiving device 19 can be checked against the certificate of the body that created the identifier. The certificate can be transmitted in the broadcast data stream or provided by some other means such as by download over the internet.

A further enhancement to the content identification system described above is to enable the detection of editing of the content. This can be achieved by the addition of a continuity count within the identifier, preferably inserted prior to application of the hashing function by the hash function generator 14. Alternatively, the continuity count could be added after the hashing function and before digital signature by the encryption module 16. In either way, the continuity count is also protected by the digital signature. The continuity count comprises a data field that increments in a known or predictable manner each time the identifier is inserted into the media data stream 11. A receiving device 19 can thereby detect unauthorised editing to the media content of the data stream by detecting any discontinuity in the embedded continuity count.

There are many situations in which a receiving device 19 may wish to alter the bit rate of a media data stream 18 that it has received from a data source 10. Examples of this are when the data stream is to be transcoded for use by a subsequent receiving device or transmission channel which operates at a lower bandwidth, lower audio or video output resolution or which generally otherwise requires some other restriction on the data. If this transcoded data stream is subsequently passed to another receiving device, the broadcaster may desire that this compromised quality of the original data stream is made evident to the end user.

When the data stream is transcoded, the stream property values in the embedded identifier will no longer match those derivable from the media data stream. Thus, to a receiving device, it will appear that the content identification provided by the identifier 12 is not authentic.

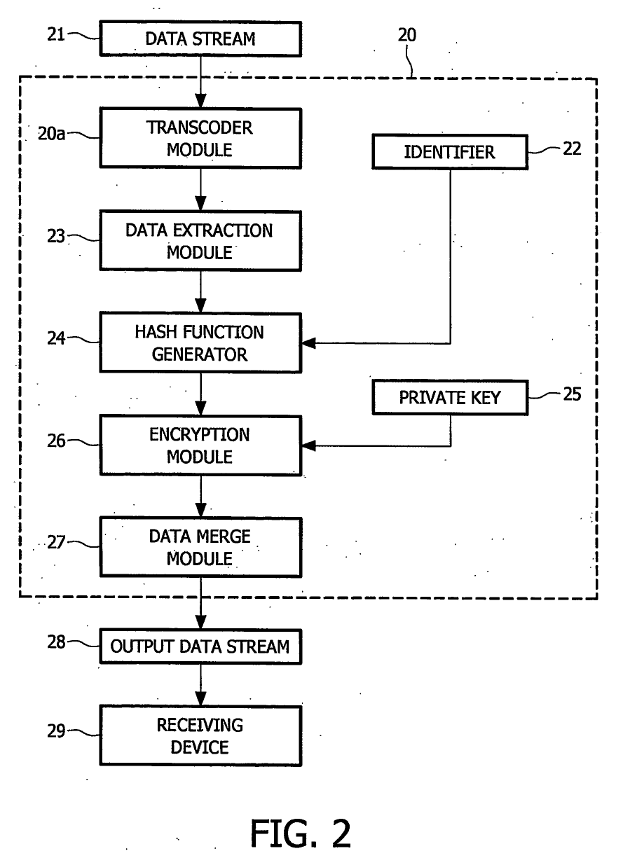

With reference to FIG. 2, to correct for this (if the transcoding operation is authorised), a transcoding device 20 receives the data stream 21 that includes the embedded and digitally signed identifiers, and replaces the identifiers with recalculated identifiers based on the newly changed properties of the data stream. Firstly, a transcoder module 20a transcodes the media data stream to its new format, eg. with lower video resolution for transmission over a lower bandwidth transmission channel. A data extraction module 23 recalculates the data stream properties for use with a new or modified identifier 22 and strips the original identifiers out of the transcoded data stream.

A hash function generator 24 then generates a new hash code output based on the recalculated data stream property and the new or modified identifier 22. The new identifier 22 may comprise data identifying the transcoding device 20 as the new data source. The new identifier 22 may retain other original data from the original identifier, if appropriate.

The hash code output of the hash function generator 24 is provided to an encryption module 26 together with the private key 25 of the transcoder 20.

The encryption module 26 digitally signs the hash code such that its authenticity can be verified by a third party having access to the corresponding public key of the transcoder 20.

The digitally signed hash code output of the encryption module 26 is then inserted into the transcoded data stream by a data merge module 27 to form transcoded output data stream 28.

The output data stream 28 may be passed to a receiving device 29 20 using any appropriate data transmission medium as previously described.

Any receiving device 29 receiving this transcoded data stream will be able to check that the identifiers match the information blocks of the media data stream to which they relate by decrypting the digitally signed identifiers using the public key of the transcoder device 20. The receiving device can use the tree of certificates to verify that the public key is authentic and that the media content is authentic.

Furthermore, to verify that the transcoding device has the authority of, or approval of, the original media content data source and provider of the original content identification data (eg. broadcaster), it is possible for the public key of the transcoding device to be digitally signed by the original content data source as well as, or instead of, the trusted third party (eg. certification authority).

Thus, as part of the signature process, the transcoding device also makes available its public key in a form that is digitally signed by the broadcasting authority or the originator of the secured content identification data. The broadcaster, or originating source 10 would only sign the public key of transcoding devices that it trusted not to label the media content incorrectly. For example, a transcoder device may modify the data stream and sign the modified identifier. When another device receives the modified stream, it will detect that the stream has been signed by another party other than the original broadcaster. However, by checking the public key of the transcoder device, the receiving device can establish that the key has been signed by another trusted party, preferably the original broadcaster.

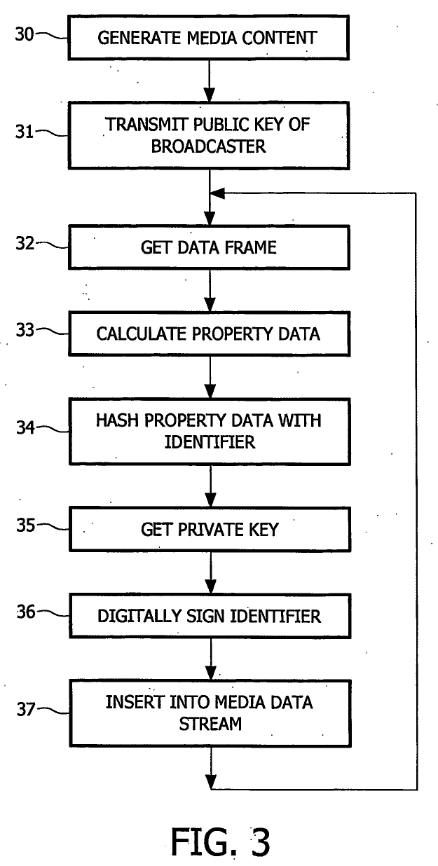

An exemplary method for inserting the identifier data is now described in connection with FIG. 3. In this example, a broadcaster or other source (eg. 10, FIG. 1) wishes to insert the identifier “crid://broadcaster.co.uk/ShopstarsEpisode12” to their broadcast of episode 12 of their series called “Shopstars”, ie the generated media content of step 30. On the broadcast channel, the broadcaster transmits (step 31) their name (eg. “broadcaster.co.uk”), their public key (eg. “AMAMA”), the name of the signature authority (trusted third party) verifying the public key (eg. intertrust.com”) and the public key signed by the signature authority (eg. “7777777”) so that the public key can be verified, by any receiving device, as the true public key of the broadcaster.

When episode 12 of “Shop Stars” is being broadcast, a first data frame of the media content is obtained (step 32) and the selected property data for that frame are extracted/calculated from the frame data (step 33). The identifier message “crid://broadcaster.co.uk/ShopstarsEpisode12” is hashed with the extracted/calculated property data (step 34).

For example, the selected property may be the size of the last I frame, and the MD5 sum (hash function) of the last I frame, which is combined with the broadcaster name “broadcaster.co.uk”, and the identifier message “crid://broadcaster.co.uk/ShopstarsEpisode12” to obtain an MD5 sum. This sum, being the hash code for insertion into the data stream, is digitally signed using the private key of the device (steps 35 and 36) and inserted into the transmitted data stream (step 37). The process then repeats for each successive new data frame, returning to step 32.

It will be noted that each time the identifier is inserted, the hash function is recalculated on the basis of new I frame data so that the identifier is intimately linked with the broadcast stream. In a preferred example, the size and hash of the previous I frame will change approximately twice every second.

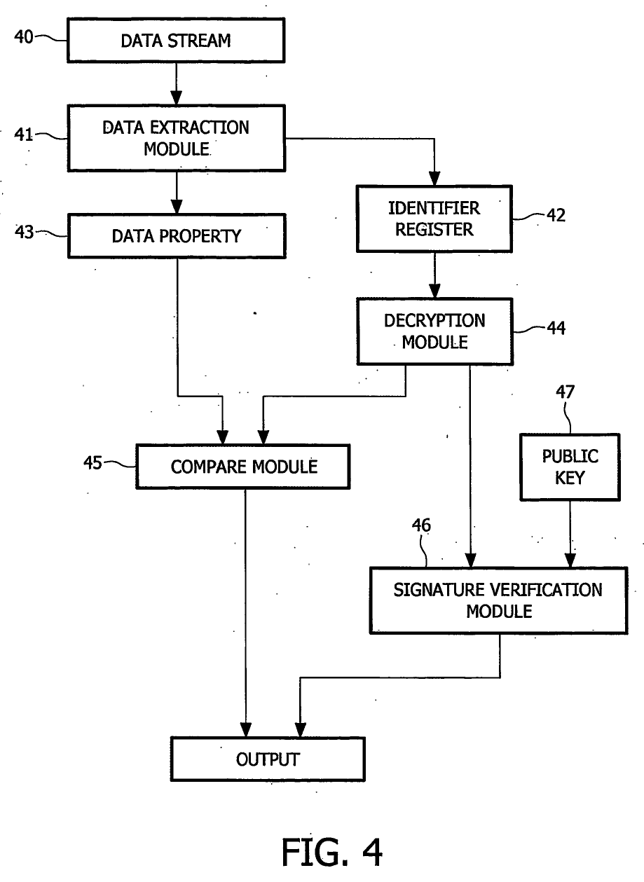

With reference to FIG. 4, a receiver device 29 will now be described in more detail. A data stream 40 is received by a data extraction module 41 that extracts (i) the predetermined property of the data stream that is used to verify the identifier, saved in register 43, and (ii) the respective copy of the secured identifier embedded in the data stream, saved in register 42.

The identifier 42 is passed to a decryption module 44 which extracts the hash code embedded and digitally signed in the identifier 22. This is compared with the calculated/extracted predetermined property 43 by a compare module 45. At the same time, the digital signature embedded in the identifier is checked by a signature verification module 46 by obtaining the public key 47 of the appropriate signature authority or authorities. This may involve obtaining the public key of a certificating authority according to known practices, to verify the authenticity of the broadcaster's public key.

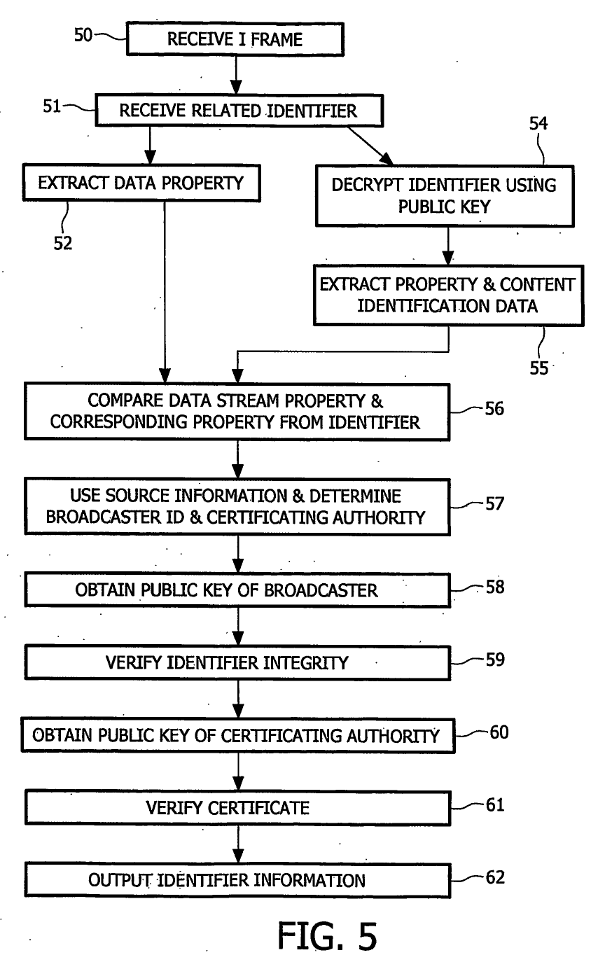

The method performed by the receiving device 29 to verify the authenticity of the inserted identifiers is described in connection with FIG. 5. The receiving device 29 obtains a first I frame (step 50) and an adjacent, embedded or related identifier (step 51). The receiver extracts the appropriate data property from the data stream (step 52). As previously described, this may comprise any suitable rapidly changing property of the data stream 11, eg. one which changes with each video data frame. In a preferred arrangement, the rapidly changing property is a combination of the frame size and the frame hash. In a preferred arrangement, a hash code of this property or properties is generated.

Contemporaneously, the related identifier is decrypted (step 54) to extract (step 55) the inserted identifier, which is a combination of the content identification data (eg. source identity) and the data stream property. The data stream property extracted from the embedded identifier is compared with the newly generated property (step 56). The extracted content identification data is then used to determine the broadcaster ID and the certificating authority (trusted third party) ID (step 57). This is then used to obtain the public key of the broadcaster (step 58) and to then verify the integrity of the identifier (step 59). The public key of the certificating authority is then obtained (step 60) and verification of the certificate made (step 61). If the authenticity of the identifier information is fully verified, the identifier information (eg. broadcaster ID and media stream information) can be output for the user (step 62).

Other embodiments are intentionally within the scope of the appended claims.

1. A method for providing content identification within a media data stream comprising the steps of:
receiving a data stream of media content;
inserting content identification data at regular intervals within the media data stream.

2. The method of claim 1 wherein the content identification data is inserted every frame.

3. The method of claim 1 wherein the content identification data is digitally combined with a predetermined property of the data stream.

4. The method of claim 1 for providing tamper resistant content identification within the media data stream, in which the step of inserting content identification data comprises the further steps of:
extracting data relating to a predetermined property of the media data stream;
combining the extracted data with content identification data;
applying a digital signature to the combined data; and
inserting the combined data and digital signature as secured content identification data into the data stream.

5. The method of claim 4 in which the step of combining the extracted data with content identification data comprises the step of forming a hash code from the extracted data and the content identification data.

6. The method of claim 1 in which the media data stream may comprise any one or more of pictures and audio or video data streams.

7. The method of claim 3 in which the predetermined property is any property of the media data stream that changes from data frame to data frame.

8. The method of claim 7 in which the predetermined property comprises any one or more of: frame size, frame hash, transport stream identifier, clock signal, and continuity count.

9. The method of claim 8 in which the predetermined property is a combination of frame size and frame hash.

10. The method of claim 5 in which the step of applying a digital signature to the hash code further includes applying digital signatures of the originator of the media data stream and a certification authority.

11. A method of transcoding a media data stream comprising the steps of:
receiving a data stream of media content including embedded, secured content identification data, in which the secured content identification data incorporates data relating to a predetermined property of the media data stream;
transcoding the media content of the data stream into a new format;
extracting data relating to a predetermined property of the media data stream in its new format;
extracting content identification data from the secured content identification data;
combining the extracted data with the extracted content identification data;
applying a digital signature to the combined data; and
inserting the combined data and digital signature as re-secured content identification data into the data stream.

12. The method of claim 11 in which the new format of the data stream has a lower resolution or transmission/storage bandwidth than the original format of the data stream.

13. The method of claim 11 in which the media content may comprise any one or more of pictures, audio, video data streams.

14. The method of claim 11 in which the predetermined property is any property of the media data stream that changes from data frame to data frame.

15. The method of claim 14 in which the predetermined property comprises any one or more of: frame size, frame hash, transport stream identifier, clock signal, and continuity count.

16. The method of claim 15 in which the predetermined property is a combination of frame size and frame hash.

17. The method of claim 11 in which the step of applying a digital signature to the combined data further includes applying a digital signature of the transcoding device.

18. The method of claim 17 in which the step of applying a digital signature to the combined data further includes the step of making available a corresponding public key of the transcoding device that is digitally signed by the originator of the content identification data.

19. The method of claim 11 in which the step of combining the extracted data with the extracted content identification data further includes the step of modifying the extracted content identification data.

20. The method of claim 19 in which the step of modifying the extracted content identification data comprises including an indication of the new format of the transcoded data stream.

21. The method of claim 19 in which the step of modifying the extracted content identification data comprises including an identity of a device performing the transcoding.

22. A method of verifying the integrity of secured content identification data embedded in a media data stream, comprising the steps of:
receiving a data stream of media content including embedded, secured content identification data, in which the secured content identification data incorporates data relating to a predetermined property of the media data stream;
extracting first data relating to a predetermined property of the media data stream;
extracting content identification data from the secured content identification data;
extracting second data relating to the predetermined property from the secured content identification data;
comparing the first data and the second data to verify the authenticity of the extracted content identification data.

23. The method of claim 22 in which the step of extracting content identification data from the secured content identification data comprises the steps of:
obtaining a public key of a content provider that secured the content identification data; and
verifying an encrypted signature of the content provider using the public key.

24. The method of claim 23 in which the step of extracting content identification data from the secured content identification data comprises the steps of:
obtaining a public key of a certification authority;
verifying the authenticity of the public key of the content provider using the public key of the certification authority.

25. The method of claim 22 in which the media data stream is received via a transcoding device, and in which the step of extracting content identification data from the secured content identification data comprises the steps of verifying that the transcoder device was authorised to modify the data stream by an originator of the content identification data.

26. The method of claim 25 in which the step of extracting content identification data from the secured content identification data comprises the steps of:
obtaining a public key of the transcoding device that secured the content identification data, the public key being digitally signed by the originator of the content identification data;
obtaining a public key of the originator;
verifying an encrypted signature of the originator using the public key of the originator, and thereby verifying the public key of the transcoder device;
verifying the content identification information using the verified public key of the transcoder device.

27. The method of claim 22 in which the media content may comprise any one or more of pictures, audio, video data streams.

28. The method of claim 22 in which the predetermined property is any property of the media data stream that changes from data frame to data frame.

29. The method of claim 28 in which the predetermined property comprises any one or more of: frame size, frame hash, transport stream identifier, clock signal, and continuity count.

30. The method of claim 29 in which the predetermined property is a combination of frame size and frame hash.

31. Apparatus for providing content identification within a media data stream comprising:
means for receiving a data stream of media content;
means for inserting content identification data at regular intervals within the media data stream.

32. The apparatus of claim 31 wherein the means for inserting comprises:
a data extraction module for extracting data relating to a predetermined property of the media data stream;
means for combining the extracted data with content identification data;
an encryption module for applying a digital signature to the combined data; and
a data merge module for inserting the combined data and digital signature as secured content identification data into the data stream.

33. The apparatus of claim 32 in which the means for combining includes a hash function generator for forming a hash code from the combined data, the encryption module applying the digital signature to the hash code.

34. Apparatus for transcoding a media data stream, comprising: means for receiving a data stream of media content including embedded, secured content identification data, in which the secured content identification data incorporates data relating to a predetermined property of the media data stream;
a transcoder module for transcoding the media content of the data stream into a new format;
a data extraction module for extracting data relating to a predetermined property of the media data stream in its new format and for extracting content identification data from the secured content identification data;
means for combining the extracted data with the extracted content identification data;
an encryption module for applying a digital signature to the combined data; and
a data merge module for inserting the combined data and digital signature as re-secured content identification data into the data stream.

35. Apparatus for verifying the integrity of secured content identification data embedded in a media data stream, comprising:
means for receiving a data stream of media content including embedded, secured content identification data, in which the secured content identification data incorporates data relating to a predetermined property of the media data stream;
a data extraction module for extracting first data relating to a predetermined property of the media data stream;
a decryption module for extracting content identification data from the secured content identification data; and for extracting second data relating to the predetermined property from the secured content identification data;
a compare module for comparing the first data and the second data to verify the authenticity of the extracted content identification data.

36. A computer program product, comprising a computer readable medium having thereon computer program code means adapted, when said program is loaded onto a computer, to make the computer execute the procedure of any one of claims 1 to 30.

37. A computer program product, distributable by electronic data transmission, comprising computer program code means adapted, when said program is loaded onto a computer, to make the computer execute the procedure of any one of claims 1 to 30.
